(19) United States
(12) Patent Application Publication
(10) Pub. No.: US 2024/0412508 A1
(43) Pub. Date: Dec. 12, 2024

(54) Obstacle detection method implemented by an aircraft embedded system and associated obstacle detection system

(71) Applicant: THALES, Meudon (FR)

(72) Inventors: Victor BAULIER, Merignac (FR); Bruno CAPELLE, Merignac (FR); Yannick LE ROUX, Merignac (FR); Baptiste IDIART, Merignac (FR)

(21) Appl. No.: 18/735,728

(22) Filed: Jun. 6, 2024

(30) Foreign Application Priority Data
Jun. 9, 2023 (FR) 23 05862

(51) Int. Cl. G06V 20/17; G06V 10/25; G06V 10/764; G06V 10/82

(52) U.S. Cl. CPC G06V 20/17; G06V 10/25; G06V 10/764; G06V 10/82

(57) ABSTRACT

The present invention relates to an obstacle detection method implemented by an obstacle detection system on-board an aircraft, the aircraft including at least one on-board camera having an associated field of view configured to acquire full-field digital images. The method comprises the steps of:
(a)—reception (50) of at least one full-field digital image captured by said at least one on-board camera,
b)—determination (54) of a spatial position of a zone of interest of predetermined size in said full-field digital image, and extraction (56) of said zone of interest from said full-field digital image,
c)—implementation of an obstacle detection module (58) on said extracted zone of interest, implementing a neural network previously trained to detect and classify obstacles in images having said predetermined size, each obstacle detected being located in said zone of interest.

This application claims priority to French Patent Application No. 2305682 filed Jun. 9, 2023, the entire disclosure of which is incorporated by reference herein.

### FIELD OF THE INVENTION

The present invention relates to a method for detecting obstacles, implemented by an on-board detection system in an aircraft, the aircraft including at least one on-board camera having an associated field of view. The invention further relates to an associated obstacle detection system and an associated computer program.

The invention belongs to the field of avionics and applies more particularly to the field of aircraft flying at low altitude, such as e.g. helicopters, drones, surveillance aircraft (forest fires, borders, etc.).

### BACKGROUND OF THE INVENTION

The term low altitude generally refers to an altitude of less than or equal to 900 meters above mean sea level (AMSL), or 300 meters above the ground if the ground is at an altitude greater than 900 meters above mean sea level.

It is necessary, for an aircraft in general, and more particularly at low altitude flight, to detect objects that may form possible obstacles, whether fixed or moving, in order to avoid possible collisions.

Hereinafter, obstacle for an aircraft refers to an object, at least a portion of which exceeds a predetermined altitude, the object being fixed or mobile. For example, fixed obstacles comprise posts, pylons, cables suspended between pylons, buildings, towers. Mobile obstacles comprise in particular other aircraft, e.g. unmanned drones.

Obstacle detection is also of general interest for geo-referenced mapping of fixed obstacles at different altitudes, e.g. skyscrapers, pylons, wind turbines, thus making possible, the implementation of obstacle avoidance strategies on the basis of such mapping.

Certain aircraft flying at low altitudes, e.g. drones or helicopters, are not equipped with obstacle detection solutions, because the existing solutions, based on optronic sensors, are expensive.

Furthermore, aircraft have limited computational and energy resources, and it is interesting to develop solutions that minimize, more particularly, the electrical energy consumption.

The subject matter of the invention is to remedy the drawbacks of known methods by providing a low energy consumption, on-board obstacle detection solution, compatible with existing on-board sensors.

### SUMMARY OF THE INVENTION

To this end, the invention provides an obstacle detection method implemented by an obstacle detection system on-board an aircraft, the aircraft including at least one on-board camera having an associated field of view configured to acquire full-field digital images. The method is implemented by a processor of a computation platform and includes steps of:
a)—reception of at least one full-field digital image captured by said at least one on-board camera,
b)—determination of a spatial position of a zone of interest of predetermined size in said full-field digital image, and extraction of said zone of interest from said full-field digital image,
c)—implementation of an obstacle detection module on said extracted zone of interest, implementing a neural network previously trained to detect and classify obstacles in images having said predetermined size, each obstacle detected being located in said zone of interest.

Advantageously, the method of the invention serves to limit the consumption of computational and energy resources, while providing precise obstacle detection due to the use of an obstacle detection module implementing a previously trained neural network.

The obstacle detection method according to the invention can further have one or a plurality of the features below, taken independently or according to all technically conceivable combinations.

The method further includes a post-processing step comprising a computation of a distance between the aircraft and the or each detected obstacle and/or a storage of a geo-referenced position, in a fixed terrestrial reference frame, for each detected obstacle belonging to a class of fixed obstacles.

The method includes the repetition of the determination of a spatial position of a zone of interest in the same wide field digital image, making it possible to obtain a plurality of zones of interest in said wide field digital image.

Before the step b) of determination of a spatial position of a zone of interest, the method includes a step of acquisition of at least one avionics information item relating to a parameter of motion of the aircraft, and the determination of a spatial position is a function of at least one avionics information item.

The avionics information item includes a path vector of the aircraft, the zone of interest being centered on a point indicated by the direction of said path vector.

Determining a spatial position of a zone of interest includes receiving a spatial position of a zone of interest through an interface for communication with an external system.

The determination of a spatial position of a zone of interest includes receiving a spatial position of a zone of interest from another sensor on-board the aircraft.

Since the camera is configured to acquire a succession of full-field digital images forming a video, steps a) to c) are implemented on a subset of acquired digital images spaced apart in time by a given time step, the method further including a time dependent tracking of the detected obstacles.

According to another aspect, the invention relates to an obstacle detection system suitable for being taken on-board an aircraft, the aircraft including at least one on-board camera having an associated field of view, configured to acquire full-field digital images, the obstacle detection system including a computation platform including at least one processor configured to implement:
a module for receiving at least one full-field digital image captured by said at least one on-board camera,
a module for determining a spatial position of a zone of interest of predetermined size in said full-field digital image, and for extracting said zone of interest from said full-field digital image,
an obstacle detection module, taking as input said zone of interest and implementing a neural network previously trained to detect and classify obstacles in images having said predetermined size, each obstacle detected being located in said zone of interest.

According to an advantageous aspect, the obstacle detection system further includes a post-processing module configured to calculate a distance between the aircraft and the or each obstacle detected and/or to store a geo-referenced position, in a fixed terrestrial reference frame, for each obstacle detected belonging to a class of fixed obstacles.

According to another aspect, the invention relates to a computer program including software instructions which, when implemented by a computer system, implement an obstacle detection method as defined hereinabove.

### BRIEF DESCRIPTION OF THE DRAWINGS

Other features and advantages of the invention will be clear from the description thereof which is given below as a non-limiting example, with reference to the enclosed figures, among which:

FIG. 1 is a synoptic diagram of an obstacle detection system in an example of implementation;

FIG. 2 schematically shows a first example of a wide field digital image including two zones of interest;

FIG. 3 schematically shows a second example of a wide field digital image including a zone of interest;

FIG. 4 is a flowchart of the main steps of an obstacle detection method according to one embodiment.

### DETAILED DESCRIPTION OF EMBODIMENTS

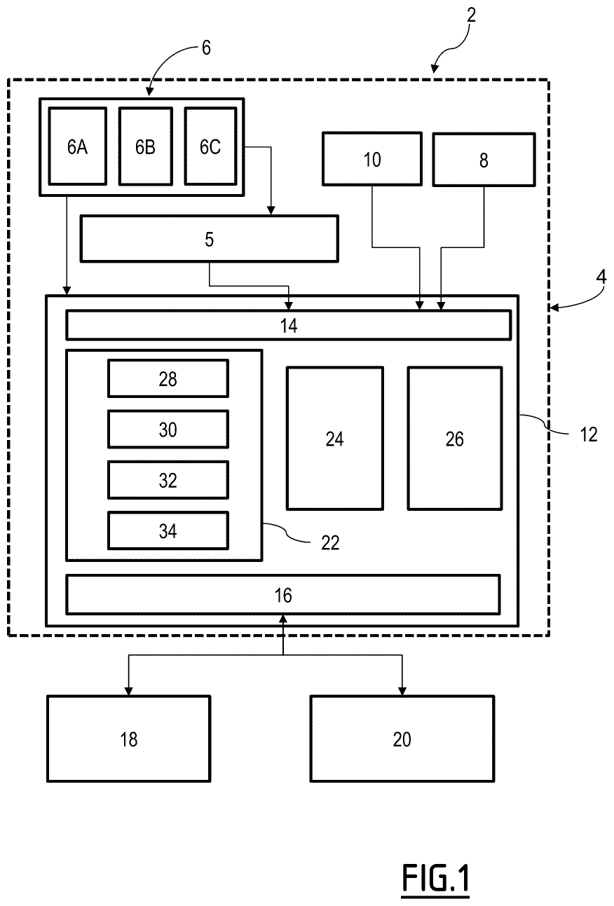

FIG. 1 is a schematic representation of an aircraft 2, equipped with an on-board obstacle detection system 4.

The aircraft 2 is equipped with a plurality of avionics instruments 6, e.g. a sensor 6A configured to provide a geo-referenced position of the aircraft, e.g. a GPS sensor, an inertial sensor 6B, and an aerodynamic data computer 6C, also called an ADC for “Air Data Computer”, configured to provide flight data from a plurality of external sensors, such as pressure probes, temperature probes, or incidence probes.

The avionics instruments 6A, 6B, 6C are given as an example, but any other known avionics instrument may be present, depending on the type of the aircraft 2.

Avionics instruments are instruments certified by avionics safety standards and provide avionics information, including information on the parameters of motion of the aircraft, more particularly flight path vectors (FPV), information on the aircraft attitude, information of the positioning in a fixed terrestrial reference frame, also called geo-referenced, e.g. GPS coordinates.

The aircraft is also equipped with a camera 8 having an associated field of view.

For example, the camera 8 is an optical camera with a wide field of view, e.g. a field of view of at least 120°, e.g. supplying successive digital images called full-field digital images, of large size. The size of a digital image is defined by the number thereof of rows and columns, in pixels. For example, full-field digital images are Ultra High Definition (or UHD) digital images, also called 4K images, e.g. with a size of 3840×2160 pixels. In a variant, a larger size is envisaged.

For example, the camera 8 is fastened to the aircraft and oriented outwards, such that the field of view of the camera encompasses a zone located in front of the aircraft, with an angular orientation with respect to a vertical axis, selected so as to capture part of the ground overflown when the aircraft is in flight.

Thereby, the detection system 4 is apt to detect both obstacles located on the ground and aerial obstacles when the aircraft 2 is in flight. The detection system 4 can be activated, e.g. by command, preferentially when the aircraft is in flight.

Of course, other variants of positioning of the camera 8 can be envisaged.

According to a variant, the aircraft 2 carries a plurality of optical cameras 8 positioned at various locations, e.g. with different orientations toward the outside of the aircraft.

As an optional addition, one or a plurality of other cameras 10, of a type different from the optical cameras 8, are also carried on-board, e.g. an infrared camera 10.

The aircraft includes, in a known manner, an avionics system referenced by 5, configured to implement avionics functions of a safety level certified by avionics safety standards, in particular configured to implement a flight management system (FMS), a guidance system, a flight control system etc. The obstacle detection system 4 includes a peripheral computation platform 12. Unlike the avionics system 5 and, more generally, on-board avionics instruments, the peripheral computation platform 12 includes, in addition to a first communication interface 14, configured to communicate with the avionics instruments 6, the avionics system 5 and more generally with all the on-board equipment certified as per avionics safety standards, a second communication interface 16, serving to communicate, by a wireless communication system, with external systems 18, 20, not subject to avionics safety standards.

For example, the first communication interface 14 is configured to communicate with the certified on-board equipment by wired communication or by wireless communication, e.g. WiFi or Bluetooth.

The second communication interface 16 is e.g. configured to communicate with non-certified external systems 18, 20, via a radio communication protocol, e.g. a 4G or 5G mobile telephony standard protocol, the SATCOM satellite communication protocol, the Datalink AOC/ATC (Aeronautical Operation Control/Air Traffic Control) protocol.

For example, the external system 18 is another aircraft, including in particular, a communication interface compatible with the communication interface 16.

For example, the external system 20 is a remote computing system located on the ground, e.g. a control center.

According to variants, the peripheral computation platform 12 comprises a plurality of second radio communication interfaces 16, according to a plurality of radio communication protocols, serving to communicate with external systems implementing different radio communication protocols.

The peripheral computation platform 12 is, in one embodiment, an electronic computation device further including a processing unit 22, including one or a plurality of processors (CPU or GPU), at least one electronic memory unit 24 and a human-machine interface 26, such elements being suitable for communicating via a communication bus (not shown).

In the example shown in FIG. 1, only a processing unit 22 and an electronic memory unit 24 are shown.

The electronic memory unit 24 includes in particular memories such as RAM, ROM, any type of non-volatile memory (e.g. FLASH, NVRAM).

The set of processing unit(s) 22 and electronic memory unit(s) 24 forms the local computation resources of the peripheral computation platform 12.

In one embodiment, the peripheral computation device 12 is modular, with a plurality of processing and memory units which can be added, which makes a dynamic increase in the available resources possible, as per the needs.

The processing unit 22 is configured for executing:
a reception module 28 for receiving at least one full-field digital image captured by the on-board camera 8, and for receiving at least one avionics information item relating to a parameter of motion of the aircraft;
a determination module 30 for determining a spatial position of a zone of interest of predetermined size in said full-field digital image, and for extracting said zone of interest from said full-field digital image,
an obstacle detection module 32 implementing a neural network previously trained to detect and classify obstacles, applied to the zone of interest of predetermined size;
a post-processing module 34.

For example, the obstacle detection module 32 implements a neural network previously trained by machine learning, e.g. a multilayer neural network, such as a convolutional neural network (CNN) or a recurrent neural network (RNN) trained by deep learning.

For example, the post-processing module 34 implements a computation of a distance between the aircraft and the or each detected obstacle and/or a storage of a geo-referenced position for each detected obstacle belonging to a class of fixed obstacles.

The modules 28, 30, 32, 34 are suitable for cooperating, as described in greater detail hereinafter, for implementing an obstacle detection method as described in more detail hereinafter, according to various embodiments.

In one embodiment, the modules 28, 30, 32, and 34 are in the form of software instructions forming a computer program which, when executed by a computer, implements an obstacle detection method according to the invention.

In a variant (not shown), the modules 28, 30, 32, and 34 are each in the form of programmable logic components, such as FPGAs (Field Programmable Gate Array) microprocessors, GPGPU (General-purpose processing on graphics processing) components, or further in the form of dedicated integrated circuits, such as ASICs (Application Specific Integrated Circuit).

The computer program including software instructions is further apt to be recorded on a computer-readable medium (not shown). The computer-readable medium is e.g. a medium apt to store the electronic instructions and to be coupled to a bus of a computer system. As an example, the readable medium is an optical disk, a magneto-optical disk, a ROM, a RAM, any type of non-volatile memory (e.g. FLASH, NVRAM), a magnetic card or an optical card.

In one embodiment, the external system 20 includes or is connected to an operational control center, including one or a plurality of interconnected programmable computing devices, or else the external system 20 is connected to cloud computing equipment. By means of the communication link established via the second communication interface, the external system 20 is in bidirectional communication with the peripheral computation platform 12. As a result, it is advantageously possible to transfer part of the computations to be performed to the external system 20, and thereby to lighten the consumption of on-board computational and electrical resources. In other words, the platform 12 cooperates with the external system 20 for the implementation of the computations, the results of the computations performed by the external system being transmitted to the peripheral computation platform 12 via the bidirectional communication link.

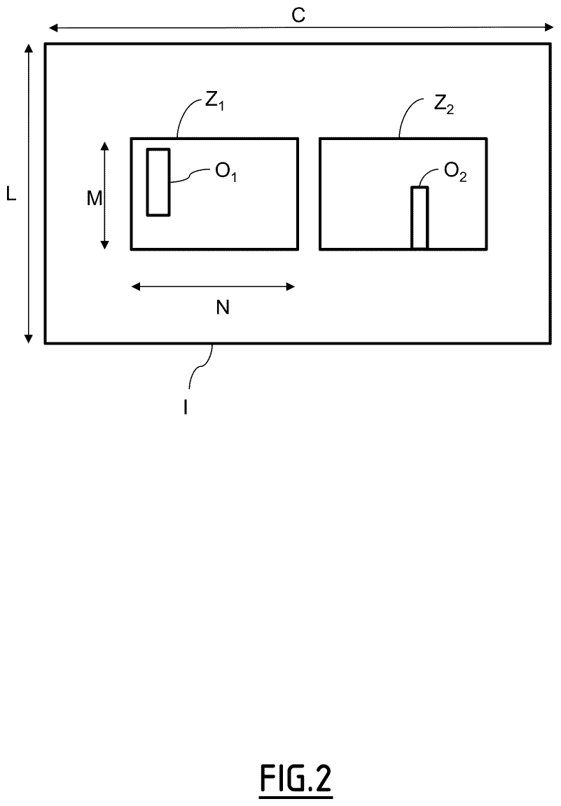

FIG. 2 diagrammatically illustrates a full-field digital image I, e.g. a UHD image, with a size of C columns by L lines, with C=3840 and L=2160 pixels.

Two zones of interest referenced by Z1 and Z2, respectively, are also represented. The zones of interest are sub-images of the full-field digital image I, of predetermined size of N columns, M rows, with N<C and M<L.

For example, N is comprised between 128 and 1024 and M is comprised between 128 and 1024, e.g. N=1024 and M=1024 or N=1024 and M=512.

The zones of interest Z1, Z2 shown in FIG. 2 are disjoint.

In a variant, the determined zones of interest may partially overlap.

Moreover, detected obstacles O1, O2 are schematically represented in FIG. 2. The obstacles are represented schematically by rectangles circumscribed to the objects. For example, the objects detected are pylons supporting electrical cables.

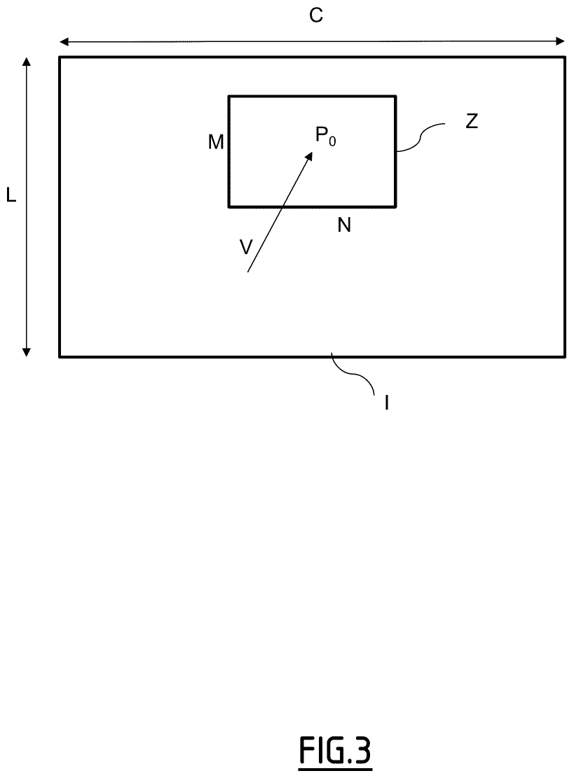

FIG. 3 also schematically illustrates a full-field digital image I, and a zone of interest determined in another embodiment. In the example shown in FIG. 3, the position of the zone of interest Z is indicated by the flight path vector V of the aircraft, representative of the direction of the path at a time t. For example, the zone of interest Z is centered on a point P₀ indicated by the vector V, which corresponds to the projection of vector V onto the field of view of the camera generating the full-field digital image I.

FIGS. 2 and 3 illustrate examples of embodiments, with the proviso that other embodiments are conceivable, e.g. tracking of a zone of interest on a plurality of successive digital images forming a video, with a chosen sampling time step: a positioning of a zone of interest as a function of an information item supplied by another on-board camera, e.g. an infrared camera; a positioning of a zone of interest as a function of an information item coming from an external system, e.g. from another aircraft, via the second communication interface 16.

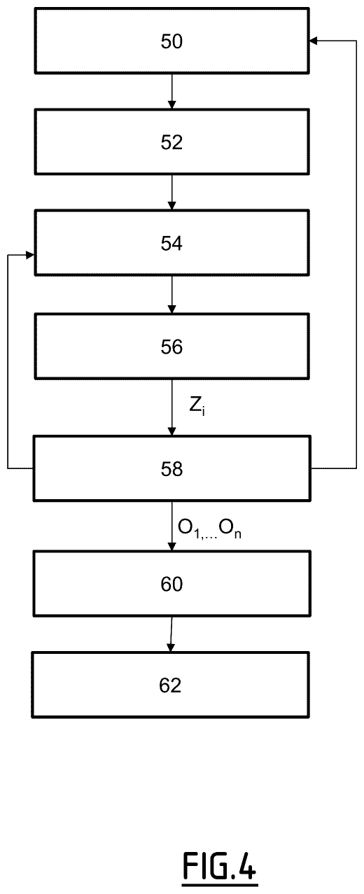

FIG. 4 is a synoptic diagram of the main steps of the obstacle detection method according to one embodiment.

The method includes a step 50 of receiving a digital image I, called a full-field digital image, captured by the camera 8. The steps of the method are then iterated, e.g. on all the full-field digital images captured by the camera, or on a subset of the captured full-field digital images spaced by a chosen time step, or in other words for a digital image on X, the number X being chosen as a function of various constraints. In such case, a tracking of the detected objects is further applied.

The position of the camera, e.g. in a spatial reference frame associated with the aircraft, the orientation of the camera and the calibration parameters of the camera are also obtained and stored, for use to ensure the conformity of the images generated.

The method further includes, optionally, a step 52 of acquiring avionics information from the on-board avionics instruments, including at least one information item relating to a parameter of motion of the aircraft, e.g. the flight path vector. Preferentially, other avionics information, e.g. the velocity vector and the attitude of the aircraft are also provided, as well as the geo-referenced position of the aircraft. For example, avionics information such as the attitudes of the aircraft (magnetic heading, attitude and inclination) comes from an inertial unit.

The method further includes a step 54 of determining a spatial position of a zone of interest in the digital image I received during step 50.

A zone of interest is preferentially a rectangular zone of predetermined size, i.e. a number N of rows and a number M of columns, N and M being previously set integers. In other words, a zone of interest corresponds to a sub-image of size N×M of the digital image I.

A spatial position of the zone of interest in a chosen spatial reference frame is e.g. indicated by the coordinates of a corner, e.g. the upper left corner, of the zone of interest in the chosen spatial reference frame. For example, the spatial reference frame chosen is the spatial reference frame associated with the digital image I.

For example, the upper left corner of the digital image I is the origin of the spatial reference frame associated with the digital image I, and the coordinates of the respective selectable points in the digital image I are the associated row and column indices.

In a variant, the spatial position of the zone of interest is indicated by the coordinates of the center of the rectangle forming the zone of interest in the chosen spatial frame of reference.

It should be noted that knowing the position and orientation of the camera, it is easy to switch from a spatial reference frame associated with the image to the spatial reference frame associated with the aircraft, then to a fixed terrestrial reference frame (or geo-referenced) knowing the attitudes of the aircraft.

A plurality of embodiments are envisaged for the determination 54 of the spatial position of a zone of interest.

In a first embodiment, the spatial position is determined randomly. For example, a pseudo-random draw is used to determine the respective coordinates (x,y) of a point P, the point P then being chosen as the upper left corner of the zone of interest. The first embodiment is particularly suitable for a mapping application with fixed obstacles, as indicated hereinafter with reference to steps 60 and 62.

In a second embodiment, avionic information is used for computing a projection point of the flight path vector (FPV), the point being chosen e.g. as the center of the zone of interest. The avionic information is e.g. the FPV and/or the derivative of the FPV, the attitudes of the aircraft, the velocity vector of the aircraft, as well as the relative position of the camera 8 with respect to the aircraft. Such embodiment is particularly suitable for avoiding possible collisions between the aircraft and an obstacle located on the path thereof.

In a third embodiment, the coordinates (x,y) of a point P, the point P being e.g. one of the corners of the zone of interest, are received from a system external to the determination step 54, e.g. from a second aircraft, distinct from the first aircraft which implements the method. Such embodiment is particularly useful for a cooperative application of obstacle detection, e.g. in the case where a first aircraft is equipped with more efficient sensors, e.g. a wide field of view camera, than the second aircraft (one or a plurality). For example, in such embodiment, the coordinates of the point P are expressed in the fixed (or geo-referenced) terrestrial reference frame and then transformed into coordinates in the spatial reference frame associated with the aircraft or into coordinates in the spatial reference frame associated with the digital image.

In a fourth embodiment, the coordinates (x,y) of a point P, the point P being e.g. one of the corners of the zone of interest, are obtained as a function of information supplied by another on-board sensor, e.g. another on-board camera. Such embodiment is particularly useful for an application of detection of obstacles detected in part by another sensor. Also in said embodiment, the position information of each camera, e.g. in a reference frame associated with the aircraft, and the orientation of each camera, as well as the respective calibration parameters, are used to perform a readjustment of the coordinates of the point P considered in a common spatial reference frame, e.g., the spatial reference system associated with the aircraft.

The various embodiments of the determination step can also be combined, resulting in the determination of a plurality of zones of interest by a plurality of distinct methods.

The method then comprises a step 56 of extracting the zone of interest, the step consisting in extracting the matrix of pixel values corresponding to the zone of interest, forming an image of size N×M, sub-image of the digital image I.

The matrix is then supplied as input to an obstacle detection module implementing a neural network previously trained by machine learning to detect and classify obstacles. The obstacle detection module is then executed during the obstacle detection step 58.

For example, a plurality of classes of obstacles are predetermined, the classes including, in particular, power towers, power lines, wind turbines, power posts, antennas, stadium projectors.

The obstacle detection module supplies, at the end of step 58, a result of detection of zero, one or a plurality of obstacles in the zone of interest processed, each obstacle having an associated class and a spatial position in the zone of interest. As a result, it is possible to compute the corresponding coordinates of the obstacle detected in the spatial reference frame associated with the aircraft and/or in the fixed terrestrial reference frame.

Preferentially, the obstacle detection module implements a neural network.

The neural network includes an ordered succession of neuron layers, each of which takes the inputs thereof from the outputs of the preceding layer.

More precisely, each layer comprises neurons taking the inputs thereof from the outputs of the neurons of the preceding layer, or from the input variables for the first layer.

In a variant, more complex neural network structures can be envisaged with a layer which can be connected to a layer farther away than the immediately preceding layer.

Each neuron is also associated with an operation, i.e. a type of treatment, to be performed by said neuron within the corresponding processing layer.

Each layer is linked to the other layers by a plurality of synapses. A synaptic weight is associated with each synapse, and each synapse forms a link between two neurons. Same is often a real number that can take positive as well as negative values. In certain cases, synaptic weight is a complex number.

Each neuron is apt to perform a weighted sum of the value(s) received from the neurons of the preceding layer, each value then being multiplied by the respective synaptic weight of each synapse, or link between said neuron and the neurons of the preceding layer, then to apply an activation function, typically a non-linear function, to said weighted sum, and to deliver at the output of said neuron, more particularly to the neurons of the next layer which are connected thereto, the value resulting from the application of the activation function. The activation function is used for introducing a non-linearity in the processing performed by each neuron. The sigmoid function, the hyperbolic tangent function, the Heaviside function are examples of activation functions.

As an optional addition, each neuron is also apt to apply, in addition, a multiplicative factor, also called bias, to the output of the activation function, and the value delivered at the output of said neuron is then the product of the bias value and of the value derived from the activation function.

A convolutional neural network is also sometimes referred to as a convolutional neural network or by the acronym CNN.

In a convolutional neural network, each neuron in the same layer has exactly the same connection pattern as the neighboring neurons thereof, but at different input positions. The connection pattern is called a convolution kernel.

A fully connected neuron layer is a layer wherein the neurons of said layer are each connected to all the neurons of the preceding layer.

Such a type of layer is more often referred to as “fully connected”, and sometimes referred to as a “dense layer”.

In one embodiment, the algorithms YOLO (You Only Look Once) and SSD (Single Shot Detector) are used for obstacle detection.

In certain embodiments, a plurality of zones of interest, which may partially overlap, are determined during step 54. In such case, each zone of interest is extracted and supplied as input to the obstacle detection step 58, which is applied as many times as there are zones of interest to be processed.

At the output of step 58 are obtained, where appropriate, a plurality of obstacles detected on the zone or zones of interest extracted from the digital image I, O₁, . . . Oₙ, each obstacle having an associated class, and being located in the zone of interest. For example, the position of each obstacle detected in the zone of interest is expressed by spatial coordinates in a chosen frame of reference.

The method then includes a post-processing step 60, which uses the result of the obstacle detection step 58.

From the position of an obstacle O in the zone of interest, expressed by first coordinates (x1,y1), it is possible to obtain the position of the obstacle O in the digital image I expressed by second coordinates (x2,y2), and/or the position of the obstacle O in the spatial reference frame of the aircraft, expressed by third coordinates (x3,y3,z3), and/or the position of the obstacle O in the fixed (or geo-referenced) terrestrial reference frame expressed by fourth coordinates (x4,y4,z4). The switch from one spatial reference frame to the other is performed by affine transformations in a known manner, within the reach of a person skilled in the art.

During the post-processing 60, the relative distance between the aircraft and each detected obstacle can be computed.

In addition, using avionic information, such as the speed of motion of the aircraft and the flight path vector, it is also possible to compute a time remaining before a possible impact if the path direction is maintained.

Furthermore, by using the avionic information, in particular the geo-referenced position of the aircraft at the time of capture of the digital image I, it is easy to compute, for each obstacle detected, and in particular for each fixed obstacle, the corresponding coordinates of the obstacle in the geo-referenced frame of reference. The position of an obstacle expressed in the geo-reference frame is called the geo-referenced position of the obstacle. The post-processing 60 may further comprise a storage of a geo-referenced position for each obstacle detected belonging to a class of fixed obstacles. As a result, it possible to enrich a mapping of fixed obstacles.

The method further comprises, optionally, an additional step 62 of using the detection of obstacles, comprising e.g. a display on the human-machine interface of the platform 12 and/or the transmission of the result of the detection of obstacles, using the second communication interface, e.g. at a ground control center.

Furthermore, if the detection of obstacles has served to detect an obstacle on the path of the aircraft, e.g. with a time remaining before possible impact Ti less than a predetermined time threshold Ts, an alarm is canceled during step 62. In a variant, an automatic modification of the path, so as to avoid a collision can be envisaged, e.g. if the aircraft is an unmanned drone.

Thereby, advantageously, the method serves to avoid a collision of aircraft in flight.

Moreover, advantageously, the method also serves to carry out a mapping of fixed obstacles, by means of an on-board solution compatible with existing on-board sensors and with low energy consumption.

The use of an obstacle detection module implementing a neural network serves to obtain a good accuracy in obstacle detection, with a controlled computational cost due to the use of zones of interest of predetermined size, compatible with a fast and efficient operation of the neural network.

In addition, the extraction of zones of interest from the full-field digital image rather than a reduction through computation of the size of the full-field digital image so as to reach the predetermined size compatible with the detection module, improves the accuracy of obstacle detection.

It should be noted that the method described hereinabove provides for the extraction of zones of interest of predetermined size, the predetermined size corresponding to the size of the input data of the detection module implementing a neural network.

Alternatively, it is conceivable to implement a plurality of sizes, depending on a plurality of levels of qualitative performance of the algorithms implemented by the obstacle detection module.

1. An obstacle detection method implemented by an obstacle detection system on-board an aircraft, the aircraft including at least one on-board camera having an associated field of view, configured to acquire full-field digital images, the method being implemented by a processor of a computation platform, and including the steps of:
a) reception of at least one full-field digital image captured by said at least one on-board camera,
b) determination of a spatial position of a zone of interest of predetermined size in said full-field digital image, and extraction of said zone of interest from said full-field digital image,
c) implementation of an obstacle detection module on said extracted zone of interest, implementing a neural network previously trained to detect and classify obstacles in images having said predetermined size, each obstacle detected being located in said zone of interest.

2. The method according to claim 1, further including a post-processing step comprising a computation of a distance between the aircraft and the or each detected obstacle and/or a storage of a geo-referenced position, in a fixed terrestrial reference frame, for each detected obstacle belonging to a class of fixed obstacles.

3. The method according to claim 1, including the repetition of the determination of a spatial position of a zone of interest in a same wide field digital image, serving to obtain a plurality of zones of interest in said wide field digital image.

4. The method according to claim 1, further including, before step b) of determining a spatial position of a zone of interest, a step of acquisition of at least one avionic information item relating to a parameter of motion of the aircraft, and wherein the determination of a spatial position is a function of at least one avionic information item.

5. The method according to claim 4, wherein said avionic information item includes a path vector of the aircraft, the zone of interest being centered on a point indicated by the direction of said path vector.

6. The method according to claim 1, wherein the determination of a spatial position of a zone of interest includes receiving a spatial position of a zone of interest using a communication interface with an external system.

7. The method according to claim 6, wherein the external system is another aircraft.

8. The method according to claim 1, wherein the determination of a spatial position of a zone of interest includes receiving a spatial position of a zone of interest from another sensor on-board the aircraft.

9. The method according to claim 1, the camera being configured to acquire a succession of full-field digital images forming a video, wherein steps a) to c) are performed on a subset of acquired digital images spaced apart in time by a given time step, the method further including a time tracking of the detected obstacles.

10. The method according to claim 1, wherein the spatial position of a zone of interest is determined randomly, a pseudo-random draw being used to determine respective coordinates of a predetermined point of the zone of interest.

11. A computer program including software instructions which, when executed by a programmable electronic system, implement an obstacle detection method according to claim 1.

12. An obstacle detection system, suitable for being taken on-board an aircraft, the aircraft including at least one on-board camera having an associated field of view, configured to acquire full-field digital images, the obstacle detection system including a computation platform including at least one processor configured to implement:
a module for receiving at least one full-field digital image captured by said at least one on-board camera,
a module for determining a spatial position of a zone of interest of predetermined size in said full-field digital image, and for extracting said zone of interest from said full-field digital image,
an obstacle detection module, taking as input, said zone of interest and implementing a neural network previously trained to detect and classify obstacles in images having said predetermined size, each obstacle detected being located in said zone of interest.

13. The obstacle detection system according to claim 10, further including a post-processing module configured to calculate a distance between the aircraft and the or each detected obstacle and/or to store a geo-referenced position, in a fixed terrestrial reference frame, for each detected obstacle belonging to a class of fixed obstacles.
